(19) United States
(12) Patent Application Publication
(10) Pub. No.: US 2025/0362041 A1
(43) Pub. Date: Nov. 27, 2025

(54) SYSTEM AND METHOD FOR CONTROLLING AIR CIRCULATION IN A SAUNA STEAM ROOM

(71) Applicant: Muhu Kodu OÜ, Pärnu (EE)

(72) Inventor: Heiki AULIK, Tallinn (EE)

(73) Assignee: Muhu Kodu OÜ, Pärnu (EE)

(21) Appl. No.: 18/872,542

(22) PCT Filed: Jun. 12, 2023
(86) PCT No.: PCT/EP2023/065699

§ 371 Date: Dec. 6, 2024

(30) Foreign Application Priority Data
Jun. 17, 2022 (EE) U202200018

(51) Int. Cl. F24F 7/007; A61H 33/06; F24F 110/10; F24F 110/20; F24F 110/70

(52) U.S. Cl. CPC F24F 7/007; A61H 33/067; A61H 2033/068; A61H 2201/0207; A61H 2201/5007; A61H 2201/5082; A61H 2201/5089; F24F 2110/10; F24F 2110/20; F24F 2110/70

(57) ABSTRACT

A system and method for controlling air circulation in a sauna steam room, having at least one fan and a fan control unit, the at least one fan being a substantially horizontal cross-flow fan having at least one air vent both at the top and bottom for air intake and exhaust. The fan is mounted on the wall behind and below the highest step of a sauna bench.

### TECHNICAL FIELD

The present invention belongs into the field of saunas, more specifically, the present invention relates to a system and method for controlling air circulation in a sauna steam room.

### BACKGROUND ART

Various equipment for controlling air temperature in a sauna are known from the prior art.

The prior art includes a solution described in European patent application EP0287106A1 (publ. 19 Oct. 1988), where the system for ventilating air in a sauna is comprised of air inflow channels and an air outflow channel, mixing chamber, heating device and a cross-flow fan. This solution is a stationary system built into the wall of the sauna steam room. Retrofitting such system into the steam room is not possible without damaging the walls of the steam room.

German patent application DE3151147A1 (publ. 28 Jul. 1983) relates to an air ventilation system of a sauna, where a cross-flow fan is integrated into a lower part of an electric heater housing. Air is sucked from a lower part of a steam room into the electric heater with a fan and is directed around the heating elements and into the channel at the back of the electric heater body, vertically upwards, between the backrest of the upper step of the sauna bench and the wall of the steam room. In addition, there are water sprinklers in said channel to generate steam. Such a combination of fan and heater does not allow to change a direction of the air flow (from bottom to top or vice versa) and also generation of an air circulation takes place only directly at the electric heater itself, i.e. in this solution the position of the fan cannot be freely selected to create optimal air circulation, but the placement of the fan rigidly connected to the body of the electric heater.

The closest solution of the prior art is the solution known from European patent application EP3167864A1 (publ. 17 May 2017), describing a system for controlling interior climate of a sauna, which is comprised of the inflow channel of hot air located in the upper part of the system, mixing chamber, a fan located in the mixing chamber, inflow channel of cooler air located in the lower part of the system, and air outflow channel located in the lower part of the system. The system should be installed into free space in the steam room.

This solution has several drawbacks. The size of the mentioned system is rather large and requires free floor space for installing in the steam room. However, steam rooms are usually relatively small, and it is difficult to find free floor space for installing the system. Furthermore, installation of such system in the steam room may cause major hazards, because various projecting parts of the system become hot and may cause serious burns upon contact with skin. Another drawback of the solution is that air outflow channel is located near the floor in the steam room, which makes floor under and around the channel hot, when hot air is blown out.

### DISCLOSURE OF INVENTION

The objective of the invention is to provide a system and method for controlling air circulation in a sauna steam room that is compact, can be installed also into a smaller steam room, is safe to use, and does not make the floor of the steam room hot. The objective of the method of the invention is to prevent the thermal layering of the air that usually takes place in a sauna steam room, during which the air temperature on the lower steps of the sauna bench decreases.

In addition to various other useful qualities, people also expect a relaxing experience from a sauna. A frequent problem in saunas is uneven air temperature at different heights and in different parts of the steam room, i.e., in the upper layers in the steam room, the air temperature is several times higher than in the lower parts of the steam room, creating a situation where the head of a person is located in heat while their feet are located in cool surroundings. This in turn causes discomfort and is also a major source of stress for the human body when the thermal regulation mechanism of the body tries to cope with different signals received from different areas of the body.

With the present invention, a system is provided for controlling air circulation in a sauna steam room, comprising at least one fan and a fan control unit. Said at least one fan is a cross-flow fan, which is located mainly horizontally and has at least one air vent both at the top and bottom for generating air circulation.

In the following text, the term “fan” refers to a cross-flow fan. Through the air vents, air is drawn into the fan from one side of the fan and is guided back into the sauna steam room from the other side of the fan. Air circulation is generated mainly in a vertical direction with at least one fan.

At least one fan is mounted on the wall behind the sauna bench and below the highest step of the sauna bench. In case of a larger steam room, at least two adjacent fans located at the same height may be mounted on the wall behind the sauna bench, or at least two fans located on different walls of the steam room, in order to generate more uniform airflow. In an embodiment of the invention, at least one fan is mounted on the longer wall of the steam room.

According to an embodiment of the invention, said at least one cross-flow fan is a reversible flow fan.

According to an alternative embodiment of the invention, the airflow is guided with at least one air vent located at the lower side of the fan at an angle away from the wall, onto which the fan is mounted.

The system for controlling air circulation in a sauna steam room of the invention comprises a fan control unit used for manual or automatic control of the operation of said at least one fan.

In a preferred embodiment of the invention, the fan control unit is set to control automatically operation of at least one fan based on at least one sensor.

Sensors are installed on the fan, or in an alternative embodiment of the invention, they can be installed also on the wall of the steam room. Sensors can be wired or wireless.

Preferably at least one air temperature sensor and at least one air humidity sensor is connected to the fan control unit, while in addition to the above-mentioned sensors, also a sensor for measuring CO₂ level can be connected to the fan control unit. This enables, e.g., to issue a warning signal in case of a dangerously high CO2 level or draw fresh air from the outside into the steam room in case of an option of fresh air intake.

The fan control unit can be also operated via a mobile application.

Use of the system and method for controlling air circulation in a sauna steam room of the invention is not limited to a specific type of sauna, e.g., it is suitable for use in a Finnish sauna or in a Russian sauna. Also, its use does not depend on the type of sauna heater, but it is equally well suitable for use in saunas with wooden heating (or any other solid fuel) as well as saunas with electric heater.

A device and system of the invention, which is already in use, can be easily disconnected and relocated to another steam room.

### BRIEF DESCRIPTION OF DRAWINGS

The present invention is described below with reference to appended schematic figures, where:

FIG. 1 shows a 3D view of a sauna steam room with a fan according to the invention;

FIG. 2 shows a top view of a sauna steam room;

FIG. 3 shows a front view of a fan on the wall of a sauna steam room;

FIG. 4 shows a side view of a fan on the wall of a sauna steam room;

FIG. 5 shows a front view of a fan according to the second embodiment on the wall of a sauna steam room;

FIG. 6 shows a side view of a fan according to the second embodiment on the wall of a sauna steam room;

FIG. 7 shows a front view of a fan according to the first embodiment;

FIG. 8 shows a bottom view of a fan according to the first embodiment;

FIG. 9 shows an axonometric view of a fan according to the first embodiment;

FIG. 10 shows an end-view of a fan;

FIG. 11 shows an end-view of a fan viewed from the motor end;

FIG. 12 shows a front view of a fan according to the second embodiment;

FIG. 13 shows a bottom view of a fan according to the second embodiment;

FIG. 14 shows an axonometric view of a fan according to the second embodiment;

FIG. 15 shows an end-view of a fan according to the second embodiment;

FIG. 16 shows an end-view of a fan according to the second embodiment viewed from the motor end;

FIG. 17 shows an end-view of a fan of FIG. 11 viewed from the motor end, where the lower air vent is equipped with air deflectors in the form of elongated fin plates;

FIG. 18 shows an end-view of a fan of FIG. 11 viewed from the motor end, where the lower air vent is equipped with air deflector in the form of elongated plate;

FIG. 19 shows a principle schematic of an air circulation system according to the invention, showing a fan and the sensors connected to the control unit.

### MODES(S) FOR CARRYING OUT THE INVENTION

The invention is described below in detail with examples of embodiments. For the sake of clarity, similar details and elements on different drawings have the same reference numbers.

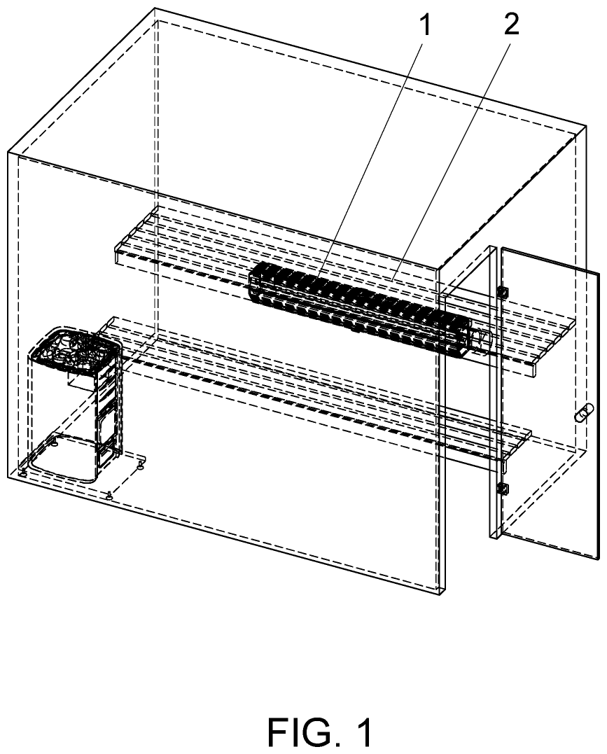

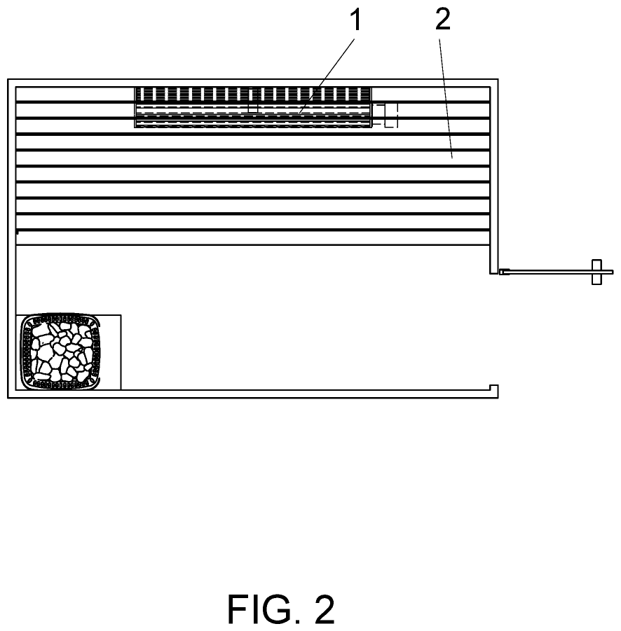

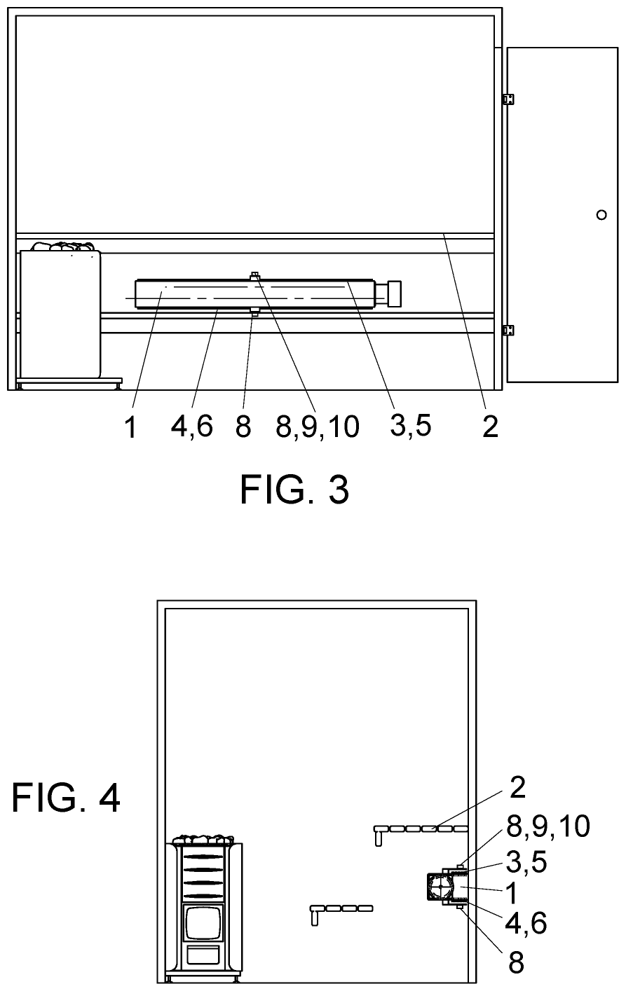

FIGS. 1 to 6 are different views of a sauna steam room with a fan 1, where the fan 1 of the invention is mounted horizontally on the wall of the steam room behind the sauna bench 2 and below the highest step of the sauna bench 2. The fan 1 of the invention is a cross-flow fan, on the upper side 3 and lower side 4 of which there are elongated air vents, respectively upper air vent 5 and lower air vent 6, for air intake and exhaust in order to generate air circulation. Advantage of a cross-flow fan with such elongated air vents 5, 6 compared to a fan with a propeller is its ability to distribute the exhaust airflow more evenly in the room, while a fan with an propeller usually directs the exhaust airflow into a single point.

The fan is mounted on the wall of the steam room so that the air vents 5, 6 at upper and lower sides 3, 4 of the fan are located on the edges closer to the wall (preferred installation) or on the edges away from the wall (not shown in the figures).

Upper air vent 5 as well as lower air vent 6 may be formed as a single vent with a grate, mesh, or lamellae placed in front of it, or it may be formed of several adjacent slots (longitudinal or perpendicular slots) or openings (e.g., perforation).

In a preferred embodiment of the invention, at least one fan 1 is mounted on the wall behind the sauna bench 2 and below the highest step of the sauna bench 2.

According to an alternative embodiment of the invention, in order to generate a more uniform airflow in the larger steam room, at least two adjacent fans 1 located at the same height are mounted on the wall behind the sauna bench 2 (not shown in the figures).

According to another embodiment, at least two fans 1 are mounted on the wall behind the sauna bench 2, which are located on different walls of the steam room (not shown in the figures).

In a preferred embodiment of the invention, at least one fan 1 is mounted behind the sauna bench 2 on the longer wall of the steam room, as shown in FIGS. 1 to 6.

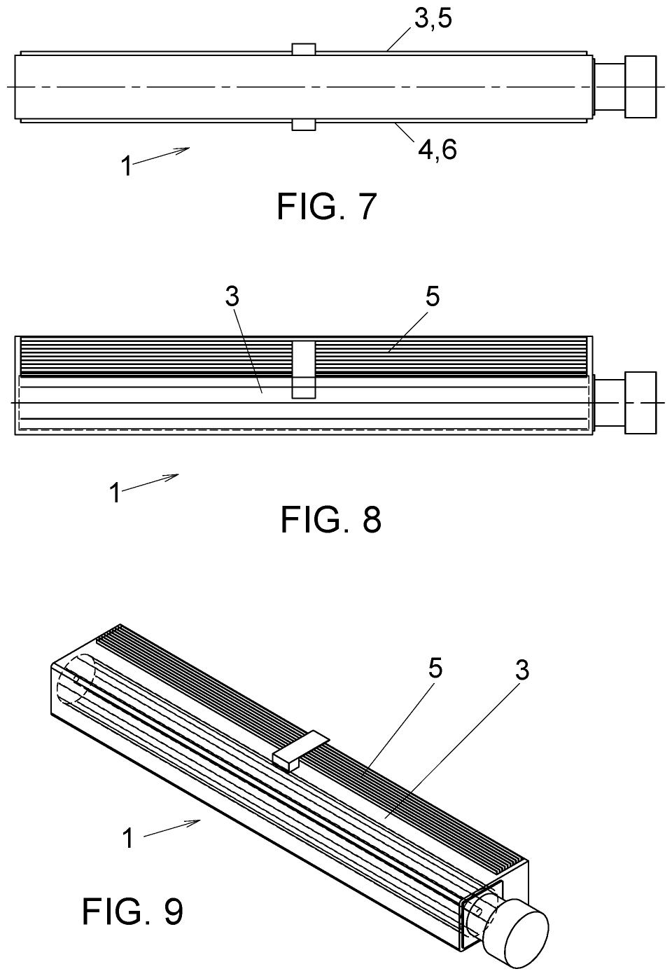

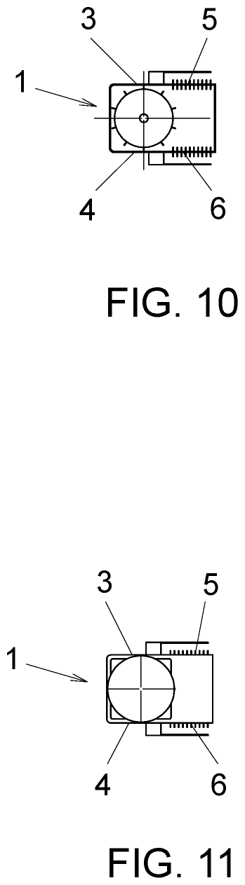

FIGS. 7 to 11 show a fan 1 of the first embodiment of the invention, where air vents 5 and 6 are located at upper and lower sides 3, 4 of the fan 1. In case of such position of the air vents 5, 6 air is drawn into the fan 1 through upper air vents 5 or through lower air vents 6, and air is exhausted from the fan 1 respectively through lower air vents 6 or through upper air vents 5.

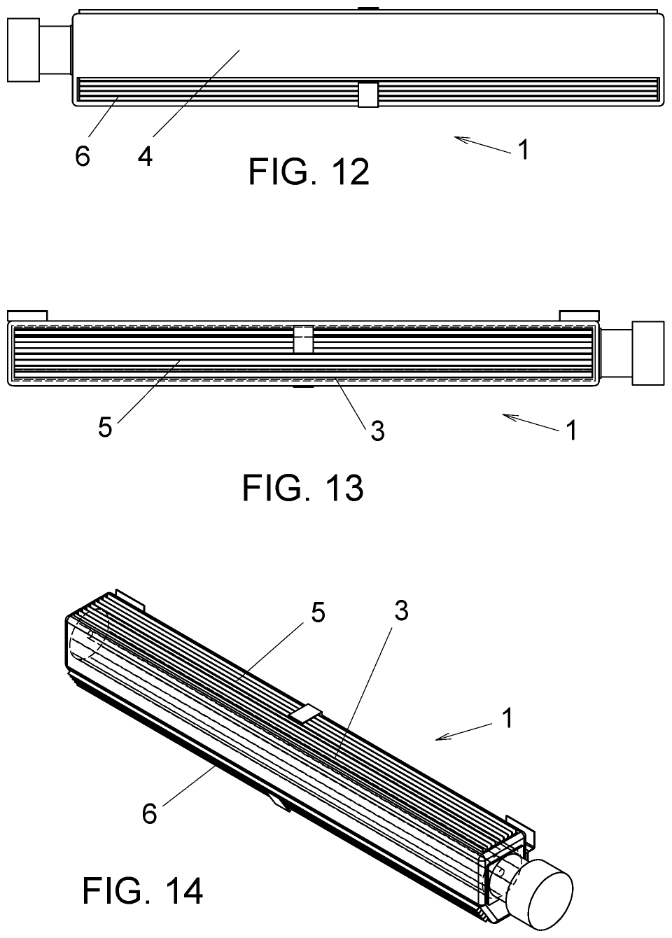

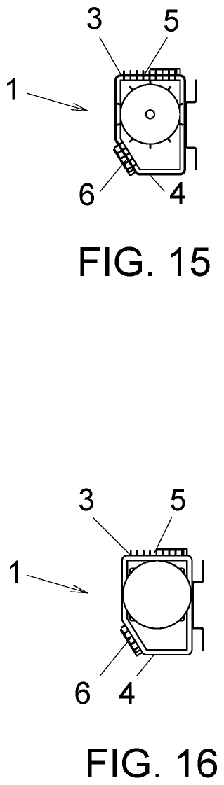

FIGS. 12 to 16 show fan 1 of an alternative embodiment of the invention, where air vents 6 located at the lower side 4 of the fan 1 are positioned at an angle in relation to the lower side of the fan 1, away from the wall, on which the fan 1 is mounted. In case of such position of the air vents 5, 6 air is drawn from the upper vents 5, and airflow is exhausted from the fan 1 through the lower vents 6 in lateral direction, away from the wall and the floor, thus creating even better air circulation. Such position of air vents also enables to install the fan 1 closer to the floor of the steam room.

According to an embodiment of the invention, the fan 1 is a reversible flow fan.

The system for controlling air circulation in a sauna steam room comprises a control unit 7 for controlling the system, which enables manual or automatic control of the operation of one or more fans 1 (FIG. 19). The control unit 7 of the fan 1 is located outside the steam room, but in an alternative embodiment, the control unit 7 may also be mounted to the fan 1.

Although FIGS. 1 to 6 and 19 show an embodiment where operation of the fan is controlled with the control unit 7, to which four sensors are connected, i.e., upper and lower air temperature sensor 8, air humidity sensor 9, and CO₂ level sensor 10, in the simplest embodiment of the invention no sensors are used, and operation of the fan 1 is controlled with control unit 7 of the fan 1 by switching the fan 1 manually on and off, whereby it can also be used for changing the rotation speed of the fan 1.

FIG. 19 shows a principle schematic of an air circulation system of the invention, showing the fan 1 and sensors connected to the control unit 7, more specifically the air temperature sensors 8, air humidity sensor 9, and CO₂ level sensor 10.

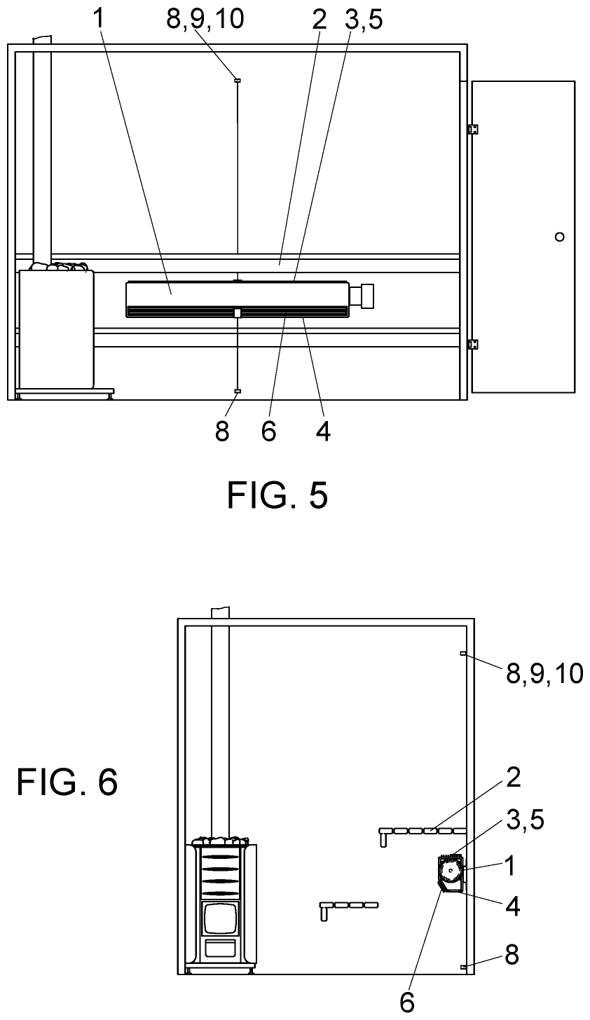

In a preferred embodiment of the invention, the control unit 7 of the fan 1 is set to control automatically operation of at least one fan 1 based on at least one sensor. In such a case, at least one air temperature sensor 8 is connected to the control unit 7 of the fan 1, which is located at the upper side 3 of the frame of the fan 1 or installed under the ceiling of the steam room with a wire, as shown in FIG. 5.

However, preferably, in addition to the air temperature sensor 8, at least one air humidity sensor 9 is also used, preferably a combined sensor that measures both air temperature and humidity in a single unit.

In addition to the above-mentioned sensors, it is also possible to connect a CO₂ level sensor 10 to the control unit 7 of the fan 1.

The system of the invention enables the use of an embodiment where only two air temperature sensors 8 are connected to the control unit 7, one at the upper side 3 of the fan 1 and the other at its lower side 4, or respectively one air temperature sensor 8 near the floor and the other under the ceiling. This enables the control unit 7 to be programmed to switch on or off according to the difference in measured temperatures, based on specified temperature differences above and below.

When choosing different combinations of various sensors 8, 9, and 10 and their location, the size of the steam room and other features such as the location of the sauna heater and air vents can be taken into account.

In a preferred embodiment of the invention, the sensor(s) is/are mounted to the fan 1. If two air temperature sensors 8 are used, one is installed in the steam room under the ceiling, and the other is installed near the fan 1.

In case of automatic control, the control unit 7 will control the operation of fan(s) 1 based on the signals received from the sensors.

In an embodiment of the invention, where CO₂ level sensor 10 is used, an intake vent of fresh air is located at the back wall of the fan 1, behind the fan 1 or slightly below the fan 1 (not shown in the figure). When the concentration of carbon dioxide in the air of the steam room is high, the air intake vent is automatically opened in the wall behind the fan 1, ensuring the inflow of fresh air into the steam room.

In an alternative embodiment of the invention using a CO2 level measurement sensor 10, an alarm signal is given when a high carbon dioxide concentration is detected with said sensor. According to an embodiment of the invention, the control unit 7 of the fan 1 can be controlled via mobile application, which enables also to switch on the sauna remotely.

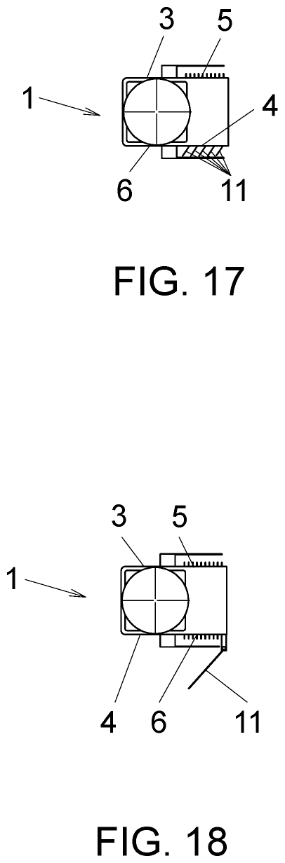

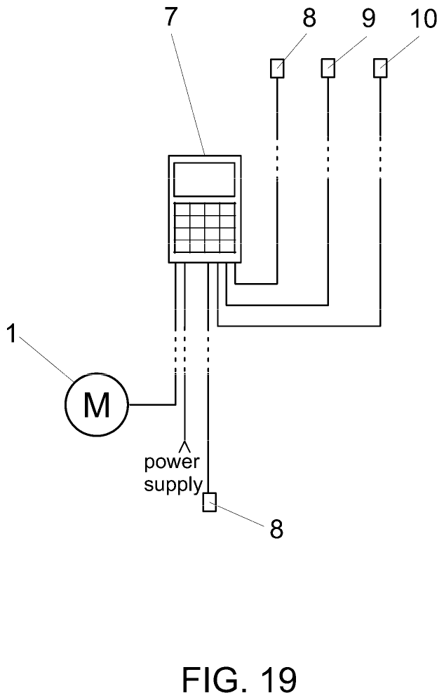

According to an embodiment of the invention, for deflecting the airflow, an air deflector or deflectors 11 may be placed in front of the exhaust air vent at the lower side 4, which are formed in front of the air vent respectively as elongated plate or elongated fin plates, whereby the angle of air deflector or deflectors 11 in relation to the exhaust air vent can be adjusted (FIGS. 17 and 18).

In another embodiment of the invention, the air deflector 11 is not mounted to the frame of the fan 1, as shown in FIG. 18, but is mounted as a separate detail onto the wall of the steam room near the lower air vent 6 of the fan 1, so that it guides, e.g., the airflow exiting from the air vent 6 away from the wall (not shown in the figures).

It is obvious to a person skilled in the art that within the scope of the appended claims, the invention can have other embodiments, and the invention is thus not limited to the embodiments described above and depicted in the figures.

### LIST OF REFERENCE NUMBERS

1—fan
2—sauna bench
3—upper side of the fan
4—lower side of the fan
5—upper air vent of the fan
6—lower air vent of the fan
7—control unit
8—air temperature sensor
9—air humidity sensor
10—CO₂ level sensor
11—air deflector

1. A system for controlling air circulation in a sauna steam room, comprising at least one fan (1) and a fan control unit (7), characterized in that, said fan (1) is a horizontal cross-flow fan, comprising both on a upper side (3) and lower side (4) at least one air vent (5, 6) for an air intake and air exhaust for generating an air circulation in the sauna steam room,
where said fan (1) is mounted on a wall behind a sauna bench (2) below the highest step of the sauna bench (2) to generate an air circulation mainly in a vertical direction.

2. The system according to claim 1, characterized in that said cross-flow fan is a reversible flow fan.

3. The system according to claim 2, characterized in that at least two adjacent cross-flow fans located at the same height are mounted on the wall behind the sauna bench (2).

4. The system according to claim 3, characterized in that said at least one cross-flow fan is mounted on the longer wall of the steam room.

5. The system according to claim 4, characterized in that behind the sauna bench (2) said at least two fans (1) are mounted onto different walls of the steam room.

6. The system according to claim 5, characterized in that the control unit (7) is set to automatically control the operation of said at least one fan (1) according to the signal of at least one sensor.

7. The system according to claim 6, characterized in that at least one air temperature sensor (8) and at least one air humidity sensor (9) are connected to the control unit.

8. The system according to claim 7, characterized in that a CO2 level sensor (10) is connected to the control unit.

9. The system according to claim 8, characterized in that with at least one air opening (4) on the underside of the fan (1), the air flow is guided at an angle away from the wall on which the fan (1) is located.

10. The system according to claim 9, characterized in that the control unit (7) is intended for automatic or manual control of the operation of said at least one fan (1).

11. The system according to claim 10, characterized in that the control unit (7) can be controlled via a mobile application.

12. A method for controlling air circulation in a sauna steam room with the system according to claim 1, whereby the steam room includes at least one fan (1), which is controlled with the control unit (7), characterized in that the method includes the steps of:
generating air circulation in the steam room with at least one fan (1), where for generating an air circulation, air is drawn into the fan (1) from one side and guided back to the sauna steam room from the other side of the fan (1),
where said fan (1) is a horizontal cross-flow fan mounted on a wall behind a sauna bench (2) below the highest step of the sauna bench (2),
where an air circulation is generated with said at least one fan (1) in a substantially vertical direction.

13. The method according to claim 12, characterized in that the control unit (7) is used for controlling operation of said at least one fan (1) automatically or manually.

14. The method according to claim 12, characterized in that the control unit (7) is used for automatically controlling the operation of said at least one fan (1) according to the signal of at least one sensor connected to the control unit (7).

15. The method according to claim 14, characterized in that at least one air temperature sensor (8) and at least one air humidity sensor (9) is connected to the control unit (7).

16. The method according to claim 14, characterized in that the CO2 level sensor (10) is connected to the control unit (7).

17. The method according to claim 12, characterized in that said at least one cross-flow fan is mounted behind the sauna bench (2) and below the highest step of the sauna bench (2).

18. The method according to claim 12, characterized in that said at least one cross-flow fan is a reversible flow fan.

19. The method according to claim 12, characterized in that at least two adjacent cross-flow fans located at the same height are mounted on the wall behind the sauna bench (2).

20. The method according to claim 12, characterized in that said at least one cross-flow fan is mounted on the longer wall of the steam room.

21. The method according to claim 12, characterized in that behind the sauna bench (2) said at least two fans (1) are mounted onto different walls of the steam room.

22. The method according to claim 12, characterized in that with at least one air opening (4) on the underside of the fan (1), the air flow is guided at an angle away from the wall on which the fan (1) is located.
